(19) United States
(12) Patent Application Publication
(10) Pub. No.: US 2009/0307199 A1
(43) Pub. Date: Dec. 10, 2009

(54) METHOD AND APPARATUS FOR GENERATING VOICE ANNOTATIONS FOR PLAYLISTS OF DIGITAL MEDIA

(76) Inventor: JAMES P. GOODWIN, Beverly, MA (US)

Correspondence Address: Saul Ewing LLP (Harrisburg);Attn: Patent Docket Clerk, Penn National Insurance Plaza, 2 North Second Street, Harrisburg, PA, 17101, US

(21) Appl. No.: 12/370,013

(22) Filed: Feb. 12, 2009

Related U.S. Application Data
(60) Provisional application No. 61/060,269, filed on Jun. 10, 2008.

(51) Int. Cl. G06F 17/30; G06F 7/00

(52) U.S. Cl. 707/4; 707/104.1; 707/3; 707/E17.009

(57) ABSTRACT

The invention concerns a method, apparatus, software, and systems for annotating a playlist of media files comprising receiving an input playlist comprising a plurality of media files, generating supplemental media files, and inserting the supplemental media files into the input playlist to create an annotated output playlist.

### FIELD OF THE INVENTION

The invention pertains to methods, systems, and apparatus for presenting digital media to consumers. More particularly, the invention pertains to a method and apparatus for generating annotated playlists.

### BACKGROUND OF THE INVENTION

Media consumers today have many ways to consume entertainment media. Specifically, consumers may consume entertainment media from broadcast television, subscription-based television networks, CDs, video cassettes, DVDs, live performances, movie theaters, terrestrial broadcast radio, satellite radio, over the internet, etc. Furthermore, the sources of media also are numerous insofar as virtually anyone with a computer and an internet connection can view, create, produce, and distribute music, videos, etc. electronically. This is in addition to the traditional ways of distributing media on recordable mediums such as CDs, DVDs, video cassettes, audio tapes, vinyl records, etc.

In connection with many of the ways typical consumers now receive media, the consumer does not always obtain significant information about the media he or she is consuming. For instance, while DJs on the radio typically announce the names of the songs and the performers and purchased CDs and DVDs come with liner notes providing a list of the contents on the CD or DVD, the performers, and typically much more information, other ways of receiving media offer very little information other than the actual media. For instance, it is common now to download music and video digitally over the Internet such that the consumer is obtaining media content with little or no written information other than the title of the song or other media content and perhaps the name of the performer. Sometimes, not even that is available. As a specific example, many Internet “radio stations” have no DJ or other announcer that announces the titles of the songs being played or the names of the performers, let alone other contextual information. Often, the only information provided is a text scroll listing the name of the performer and the title of the song. Accordingly, nowadays, media consumers frequently may consume media content while having very little information available about the media content.

Even further, nowadays, media consumers can listen to music and/or other audio content and/or watch video and/or multimedia content, not only using traditional means such as on a television set at home, via radio, at a movie theater, but also by newer technologies such as on a computer, on a portable multimedia playing device (such as a portable DVD player, MP3 player, IPod™, cell phone, etc.) The media content may be streamed or otherwise transmitted to the consumer's device in real time, as is commonly the case for broadcast television or radio, via the Internet, via a cellular telephone network, or via other networks. Alternatively, the media content may be stored in a memory local to the consumer, such as a DVD, CD, or the memory of the consumer electronic device such as a hard drive of a computer or an IPod™ or the solid state memory of a portable MP3 player.

Furthermore, consumers now consume audio, video, and multimedia content on-the-go from portable personal devices (such as the aforementioned IPods™ or MP3 players), so that even the minimal contextual information that is available is nevertheless inconvenient to access. For instance, many people listen to portable digital media players such as IPods™ on headphones while exercising, driving, walking, running, or performing some other task. Accordingly, while, for instance, many digital portable music players have a display screen that displays the name of the artist and the title of the song currently being played, it may be difficult or impossible for the consumer to actually look at it while engaged in some other task.

Due to the sheer amount of available media content, the ease with which it may be obtained, the low cost at which it can be purchased, the ease of sharing media content with others, and the vast amount of memory often available even on the smallest of portable devices that can store thousands upon thousands of media files, consumers now often do not even necessarily recognize music that they loaded on their personal media players merely by hearing it. For instance, it is not uncommon for a person having a keen interest in music to own and have stored on his or her computer and/or portable media player 5,000 or more individual pieces of music (e.g., songs), video, or other media. Many personal media players have one or more “shuffle” options in which the songs on a particular album or from a particular artist, or all the songs stored on the entire device can be played in a random order. Thus, making it even more difficult to recognize each such song simply from hearing it.

### SUMMARY OF THE INVENTION

The invention concerns methods, apparatus, software, and systems for annotating a playlist of media files comprising receiving an input playlist comprising a plurality of media files, generating supplemental media files, and inserting the supplemental media files into the input playlist to create an annotated output playlist.

### BRIEF DESCRIPTION OF THE DRAWINGS

FIG. 1 is a block diagram of the components of a system in accordance with a general embodiment of the present invention.

FIG. 2 is a block diagram of the components of a system in accordance with a first specific embodiment of the present invention.

FIG. 3 is a block diagram of the components of a system in accordance with a second specific embodiment of the present invention.

FIG. 4 is a block diagram of the components of a system in accordance with a third specific embodiment of the present invention.

FIG. 5 is a flow diagram illustrating general process flow in accordance with a particular embodiment of the present invention.

FIG. 6 is a flow diagram illustrating process flow for the playlist generator in accordance with a particular embodiment of the invention.

FIG. 7 is a flow diagram illustrating process flow for the content index and content store in accordance with a particular embodiment of the invention.

FIG. 8 is a flow diagram illustrating process flow for the content extractor in accordance with a particular embodiment of the invention.

FIG. 9 is a flow diagram illustrating process flow for the playlist annotator in accordance with a particular embodiment of the invention.

### DETAILED DESCRIPTION OF THE INVENTION

The invention offers systems, method, software, and apparatus for inserting media annotation files within a playlist or other set of media files. In one embodiment, the media annotations comprise information about the media items in the playlist or other set of media items. In one embodiment, the annotation files are interleaved between each pair of adjacent media files in the input playlist. In one embodiment, the media annotation files are of the same media type (e.g., audio, video, multimedia) as the media file that it is annotating. Thus, for instance, if the original input playlist comprises audio files, e.g., MP3s, the media annotation files also will comprise audio files. Preferably, they also are MP3 files.

For instance, taking as an example a playlist of songs, the invention may insert an audio annotation file immediately before or after each song in the playlist, the audio annotation file comprising speech announcing the title of the song and the name of the performer performing it. Commonly, the title of the song and the name of the performer that is performing a song is available in the meta data already within the media file comprising the song. Accordingly, in this embodiment, software may read this meta data directly from the song file and convert it to an audio file using a text-to-speech converter and insert that audio file within the playlist right before or after the sohg file to which it corresponds. In other embodiments, the audio annotation file may further include boilerplate language surrounding the spoken song tile and/or performer name, such as “That was” [SONG TITLE] “by” [PERFORMER NAME]. In yet other embodiments, the software may analyze the meta data or even the primary data stream to derive contextual information about the files (e.g., song title, performer name) and use it to locate even further information about the file content from an external source, convert it to speech if necessary or desired, and insert that external information into the annotation file.

The term “meta data” is used herein in its conventional sense to refer to data within a digital file that is hidden in the sense that, during normal playback of the file, the meta data is not presented as part of the primary output stream. Thus, for instance, in an MP3 player, the primary output stream is the audio output to the headphones, whereas the meta data comprising the song titles, performer names, or other information about the primary output may not be output in a humanly perceptible manner or may be output in a secondary output stream. For instance, many MP3 players will output some or all of the meta data, such as song title and performer name, in a secondary stream to a display screen on the MP3 player. This is meta data because it does not form part of the primary output stream, i.e., the music.

Furthermore, the term “media” is used herein to denote content within a digital file that is intended to be humanly perceptible in the normal playback of the file. This would ordinarily comprise audio, video, or both (multimedia), but could, particularly in the future, comprise output that is otherwise humanly perceptible (e.g., touch, smell, taste).

External data can be obtained from virtually any source. Such information may, for instance, be obtained via the Internet. For instance, websites such as CDDB (a CD database service), allmusic.com, and Wikipedia offer information for free about many musical performers and songs. For example, the meta data indicating the title of a song and the performer can be used to create a search string for searching for information about that song or performer on the Internet in general or from specific, designated websites such as CDDB, allmusic.com, or Wikipedia. Merely as a simple example, a search can be performed for information on Wikipedia about the performer identified by the meta data associated with a song file and the first paragraph of any entry found relating to that performer may be converted to an audio speech file using a text-to-speech converter and made part of the audio annotation file.

In yet other embodiments in which the invention may form part of a hosted Web service, the Web site operator may provide its own database of information (content repository) in a form that requires no further conversion (i.e., it is already in the form of an annotation file, such as an MP3 file comprising a synthetic or real voice announcing the song title and performer name).

With respect to consumer electronic media player devices that have network connectivity either wirelessly (e.g., an iPhone™ or other cellular telephone with media playing capability) or through a wired connection (e.g., a personal computer connected to the internet or other network over land lines), such information can be obtained in real time. For instance, the information can be obtained and the audio annotation file built when a playlist is first created or while the song is playing so that it is ready for playing when the song has finished playing. This may be done for every media file stored on the player (i.e., the playlist comprises all media files on the device).

With respect to devices that do to have direct connectivity to the Internet (or other sources of external information), like an IPod™ or a conventional portable MP3 player, the playlist with audio annotation files containing external information interleaved therein can be created on another device that does have such connectivity (e.g., a personal computer running the ITunes™ software application) and then the annotated playlist can be downloaded or “synced” to the portable device.

As will be discussed in further detail below, the various components utilized to implement the invention may be contained within one device (e.g., the media player) or may be distributed among a plurality of devices or network locations. Particularly, in one embodiment, all of the components for implementing the invention may be located in the media player device itself. In other embodiments, the components may be distributed between the media player device and another consumer device (e.g., a computer running the ITunes™ application). The media player device may by synced to the other device in the nature of an IPod™ syncing with the ITunes™ application running on a desktop computer. In yet other embodiments, the components may be distributed in a network amongst a client device (e.g., the consumer's media player device and/or home computer) and one or more server-side nodes on the network.

Furthermore, while the invention has primarily been discussed above in the context of an application in which it is used in connection with a playlist of musical pieces, this is merely exemplary. The invention can be used in connection with virtually any type of file, including audio, video, multimedia, and other entertainment media type files. It also may be implemented in connection with non-entertainment media, such as instructional audio or video recordings (e.g., guitar lessons, assembly instructions for home-built aftermarket car accessories, foreign language lessons), informational audio, video, or multimedia files (e.g., news, weather, traffic, sports), or even non-media files.

It also should be noted that, usually, a playlist typically does not actually comprise the media files or the audio annotation files assembled together. Rather, the playlist per se usually is just a series of pointers to the actual files containing the content. The actual files are retrieved by the playback component near the end of the playback of the preceding file. Also, while a typical playlist has an order for the files in the playlist, this is not a requirement. Playlists often are played in shuffle mode anyway. It should be noted, however, that the position of a particular annotation file relative to a particular media file may be significant in many, if not most cases. Therefore, it often will be desirable to maintain some order in a playlist include annotation files in accordance with the present invention. For instance, it will generally be desirable for the annotation files that correspond to a particular media file (e.g., the announcement of what song was just played) to be positioned and to remain adjacent their corresponding media files, even in shuffle mode. Even where an annotation file does not necessarily correspond to any particular media file, some particular position within the playlist of the annotation file may be required or desired. For instance, if an annotation file comprises today's weather report and the media files comprise songs, the media file is does not correspond to any particular file. Nevertheless, while the songs may be shuffled and played in any random order, it still may be desirable to play the annotation file at a particular temporal position within the playlist.

In addition to providing audio annotations containing information pertaining to the files in a playlist or other set of media files, the technology may be utilized to personalize and/or provide a listening, viewing, etc. experience having more of a sense of human interaction. More particularly, while listening to music on a personal media player has many benefits as compared to, for instance, the radio, including total freedom to choose what to listen to and absence of commercial interruptions, it does have some potential disadvantages. For instance, the absence of a DJ or radio announcer makes the listening experience more impersonal. Also, the lack of supplemental information of significance, such as news, sports, traffic, and/or weather information, may be viewed as a disadvantage.

Thus, for instance, one could insert annotation files containing useful supplemental information having no specific relation to the content of the other media files in the playlist. Such information can be downloaded from a network such as the Internet or a wireless cellular telephone network, to the consumer electronic device. The consumer can choose to receive only information of a type or nature that the consumer wishes to receive (sports and weather reports, but no traffic or other news).

Furthermore, with the addition of a small amount of boilerplate language added to the informational content, the presentation of the content and information can be made to sound very much like a typical radio announcer reading the news, sports, weather, or traffic report.

In yet other embodiments, personal information relevant only to the owner of the -particular consumer electronic device may be converted to speech and interleaved with other media files in a playlist. For instance, it is not uncommon for a single consumer electronic device to serve multiple functions, such as a cellular telephone, media player, clock, e mail device, and personal digital assistant. Accordingly, a playlist of musical selections can have interleaved within it audio annotation files announcing the individual's personal appointments for the day from his or her electronic calendar or may announce incoming e mails or even read e-mails received on the device. Such an embodiment would enable a person to both have an enjoyable entertainment consumption experience as well as receive useful information while commuting to work in the morning or exercising at the gym or performing any other activity that requires an individual to use his or her eyes for a purpose other than looking at a display screen on a consumer electronic device.

Annotation files maybe inserted in any reasonable organization. For instance, in a song playlist, it may be reasonable to have 3 or 4 song tracks inserted in a row before the next annotation file (and that annotation file may provide information for the 3 or 4 preceding tracks). Annotation files also may be grouped into a ‘break’ like in a radio show where the DJ talks about the last 3 or 4 artists or songs just played followed by template content to introduce the next tracks. The “break” might also include an annotation file that pulls in content like the user's appointments or the weather or news, not necessarily related to the media files per se.

The invention may be implemented as part of a Web service in which a consumer can subscribe to certain channels dedicated to certain types of information (e.g., sports, news, weather, traffic, music, television, movies, politics, current events, etc.). The service provider may generate or obtain the data on its own or perform data mining via the Internet to obtain some or all of the information from third-party providers (e.g., websites).

Some of the annotation files may comprise or contain advertisements.

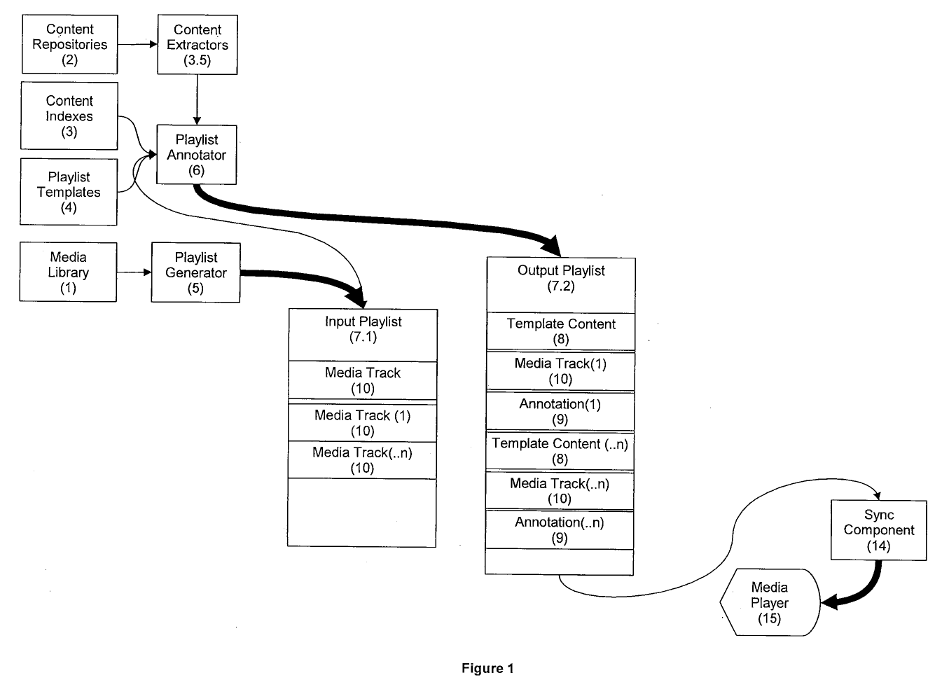

FIG. 1 is a block diagram illustrating components of the system in accordance with one particular embodiment of the invention. The illustrated embodiment is specifically adapted for use in connection with a digital music player device in which musical playlists are created by some automated form. However, this is merely exemplary and not limiting.

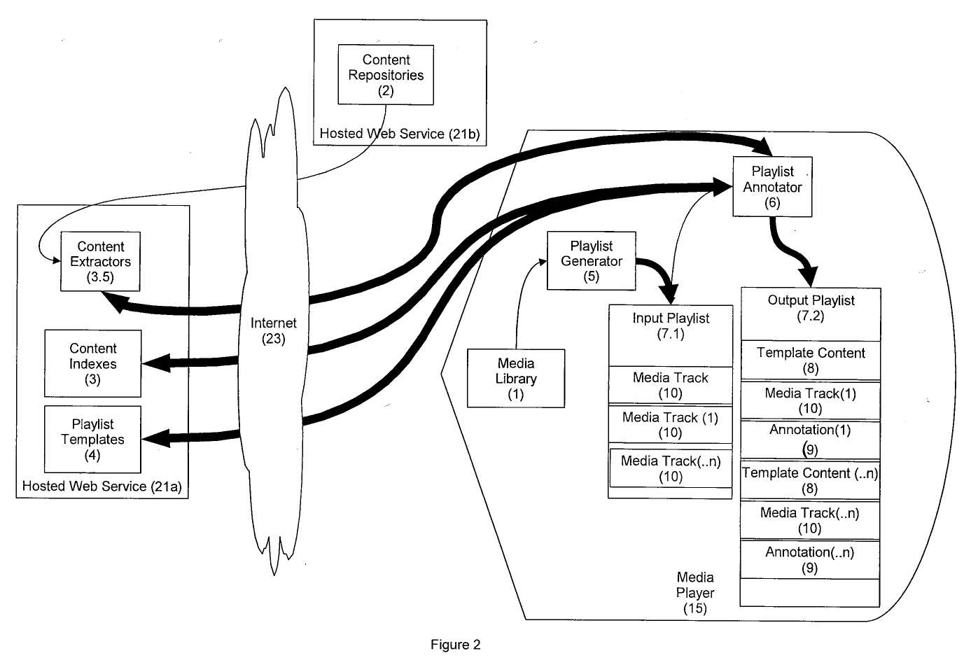

In the block diagram, each block essentially represents a software construct, such as a software application or digital data. In FIG. 1 (as well as FIGS. 2-4 discussed below), the arrowed lines indicate data flow, wherein the thinner arrowed lines indicate read operations and the thicker arrowed lines indicate write operations. The direction of the arrow indicates the target of the respective reading or writing operation. In the most practical implementations, the components comprise primarily software running on a digital processing device, such as the digital signal processor, microprocessor, general-purpose computer processor of a media player, computer or other consumer electronic device, or a server on a network. As mentioned above and as will be discussed in more detail below, all the software components may reside within a single device. However, in other embodiments, particularly, hosted Web service embodiments, the software components may be distributed among a plurality of devices and/or network nodes.

Furthermore, while a software implementation is probably the most practical implementation, some or all of the functionality described herein can be provided by other means, such as combinational logic circuits, analog circuits, application-specific integrated circuits (ASICs), state machines, field programmable gate arrays (FPGAs), and combinations thereof.

In any event, the exemplary system comprises a media library 1. This is a library of media files, some or all of which might be organized into a playlist. The media library may comprise virtually any source of media files. For instance, in an MP3 player, the media library would essentially comprise the library of songs stored on the MP3 player. In other embodiments, the media library 1 may be provided by a third party from a remote location. For instance, the media library 1 may be provided by an Internet-based music service, such as Rhapsody™, having a media library to which a media player device (e.g., a personal computer or MP3 player) has access (e.g., either through a download operation or via real-time streaming over a wired or wireless connection). As is common, the media files may include meta data in addition to the primary content. For instance, this may comprise the title of the song, the name of the performer, the album on which it appears, the date it was released, the musical genre, the date it was added to the library, the year of its public release, etc.

The user of the consumer electronic device may create his or her own playlists using conventional techniques. However, alternatively, a playlist generator 5 may be provided that automatically creates playlists based on some criteria either generated automatically or based on user selection(s).

In any event, an input playlist 7.1 is created comprising a plurality of media files.

A content repository 2 stores data that may be placed within an audio annotation file. Again, the content repository 2 may exist on the media player device itself or may be located remotely of the player, such as on a server on the Internet. The content repository 2 may be virtually any source of information. Examples of potential content repositories include Wikipedia, Allmusic.com, the data stored in the calendar or e mail application on a PDA (Personal Digital Assistant), databases on a local area network, databases stored directly on a media player, etc.

A content index 3 may be provided that indexes the data stored in the content repository 2. The content index 3 is used for mapping the meta data derived from the media files in the media library (or any other available information about the content of the media files or otherwise) to content in the content repositories 2. There may be multiple content repositories 2 and each may have a content index 3.

As will be discussed in more detail below, in one example, the meta data taken from a file in the media library 1 (e.g., a song title and/or performer name) may be input to the context index 3 to find a data set in the content repository 2 corresponding to that meta data.

In some instances, the files in the media library 1 may not contain meta data, such that even basic information must be obtained from a content repository 2 based on some criteria available from the media file. For instance, the media file may only have an ID number, which can be associated with a song title or performer name only by consulting an index.

A content extractor module 3.5 performs the task of pulling useful data that can be placed within an audio annotation file out of a data set found in the content repository 2. Thus, for example, if a media file in a playlist contains meta data indicating that it is the song “She Sells Sanctuary” performed by the band “The Cult”, those keywords are input into the content index 3, which, hopefully, identifies at least one data set in the content repository 2 containing those key words (e.g., a web page on allmusic.com about the band The Cult). The content extractor 3.5 then analyzes the identified data set and attempts to extract from it information that can be inserted into an audio annotation file. For example, the content extractor may 3.5 execute an algorithm that attempts to identify declaratory sentences including the name of the performer or song such as by looking for sentence that include the keywords as well as words such as “is” or “was”. Alternately or additionally, it may be configured to identify and extract the lead paragraph of a relevant web page. It also may be configured to limit the length or amount of data extracted to be within a predefined range and/or to assure that content breaks occur in sensible places, such as at the ends of sentences or paragraphs.

Depending on the particular implementation, the content extractor module 3.5 may be superfluous. For instance, if the data in the content repository is already stored as a media file developed for purposes of being an audio annotation file (as it may be in the case of a hosted Web service that maintains its own content repositories), then a content extractor may be superfluous insofar as the process may be as simple as retrieving the appropriate annotation file from the content repository that is located by the content index 3. In other embodiments in which, for instance, the content repositories are not purpose-built for use with the invention, a content extractor may be necessary. For instance, if the hosted Web service uses a third party database, such as Wikipedia, as the content repository, the content extractor module would likely need to incorporate some intelligence to extract the most pertinent data from Wikipedia web pages identified using the content index.

A template library 4 stores a plurality of possible templates for use in creating annotated output playlists 7.2

A playlist template sets forth a template for the audio annotation files as well as a template for how to interleave the audio annotation files into the input playlist to generate the output playlist. For instance, a template might dictate (1) that an audio annotation file corresponding to each song in the input playlist be inserted after each corresponding song and (2) that each audio annotation file comprises speech announcing the title and performer of the song in the form “That was [SONG TITLE] by [PERFORMER]” followed by any content extracted from the content repository 2 by the content extractor 3.5.

The template library 4 may contain one template or many different templates to be used as a function of the type of playlists and/or type of annotations to be added to it. The template may be selected by the user or may be automatically selected based on some reasonable criteria that can be derived from the input playlist 7.1. For instance, a playlist that comprises music files may use one particular template, whereas an input playlist comprising instructional video recordings might use a different template or a new, sports, weather template may be different than a musical information template

Next, a playlist annotator 6 receives as inputs (1) the data extracted by the data extractor 3.5, (2) the input playlist 7.1, and (3) an annotated playlist template selected from playlist template library 4. The term playlist is used herein to denote essentially any organized set of files.

The playlist annotator 6 creates the audio annotation files by inserting the extracted content into the selected template in the manner and form dictated by the selected template and then inserts those audio annotation files into the input playlist 7.1 in positions dictated by the selected template to produce an output playlist 7.2.

Assuming an embodiment of the invention in which the playlists are created on a device (e.g., a personal computer) separate from the media player (e.g., an IPod™), then the output playlist 7.2 is transmitted to the media player 15 such as through a synchronization application 14. On the other hand, in embodiments in which playlist annotator 6 is embodied in the actual playback device, no synchronization application would be needed.

It should be noted that, in embodiments of the invention that only convert the meta data contained in the media files into audio annotation files and insert them into playlists, there would be no need for the content repository 2, the content index 3, or even the playlist template library 4 (e.g., there could be only one “template” and that template could be coded directly into the playlist annotator 6 code).

The blocks in the diagrams are provided for conceptual purposes and do not necessarily indicate that the functionality of a block is provided by a distinct software, firmware, or hardware module from any other block. For instance, there is no reason why the template library 4 could not be built right into the playlist annotator 6.

FIG. 1 illustrates the components of the invention in general terms without concern as to the locations of the various components. FIGS. 2-4, however, illustrate different exemplary embodiments and illustrate the likely locations of the various components for those particular embodiments.

For instance, FIG. 2 illustrates an embodiment of the invention wherein the audio annotations are provided to media consumers as a hosted Web service. In this embodiment, the media player 15a contains the media library 1 and, optionally, the playlist generator 5. These components typically might be found in a media player regardless of whether the media player is adapted to operate in accordance with the principles of the present invention. In this particular embodiment, the media player 15 further comprises the playlist annotator 6, although this alternatively could be at the hosted Web server. The hosted Web service 21a communicates with the media player 15 through the Internet 23 or some other network. The server of the hosted Web service 21a comprises the content index 3, the playlist templates library 4, and the content extractor 3.5. A third party web site 21b hosts the content repository.

In this embodiment, the annotator 6 receives the input playlist 7.1 and sends information about the playlist (e.g., the embedded meta data, such as the song titles and performer names) over the Internet 23 to the hosted Web service 21a. The content index 3, content extractor 3.5, and playlist template library 4 use the playlist information to extract content from the content repository 2 as dictated by the content index 3 and returns to the playlist annotator 6 the template for the output playlist as well as the content that will comprise the audio annotation files. The playlist annotator 6 can then build the audio annotation files and interleave them into the input playlist 7.1 to produce an output playlist 7.2, as previously described.

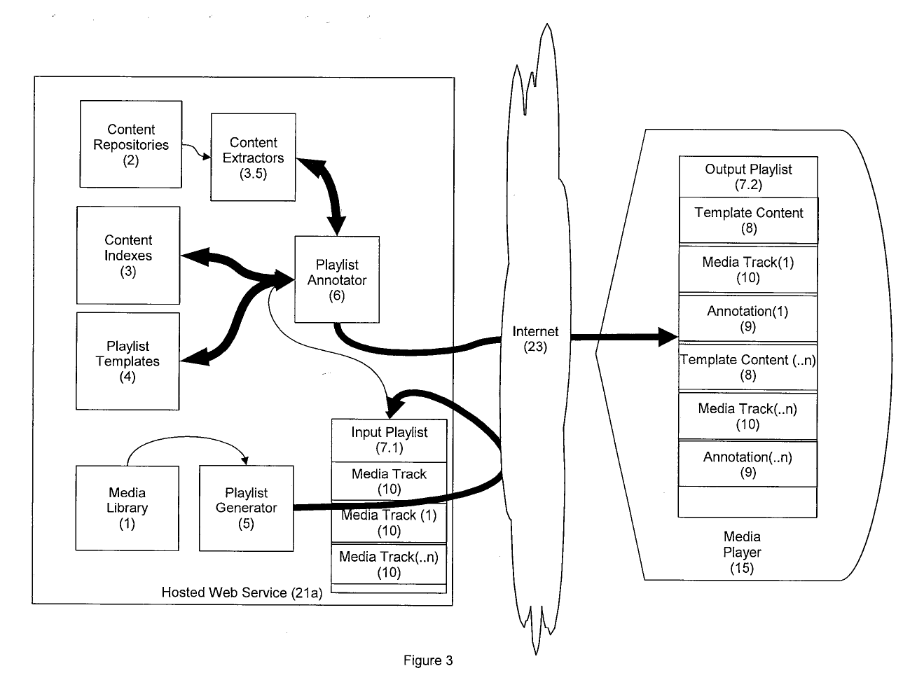

FIG. 3 illustrates another form of hosted Web service embodiment of the invention in which the Web service not only provides the annotation data, but also provides streaming media to a media player. In this embodiment, essentially all of the components are found at the hosted Web service site 21c. The media player 15b is configured merely to receive the output playlist 7.2 via the Internet 23 (or other network or connection) from the hosted Web service 21b (or other device to which it can be connected.

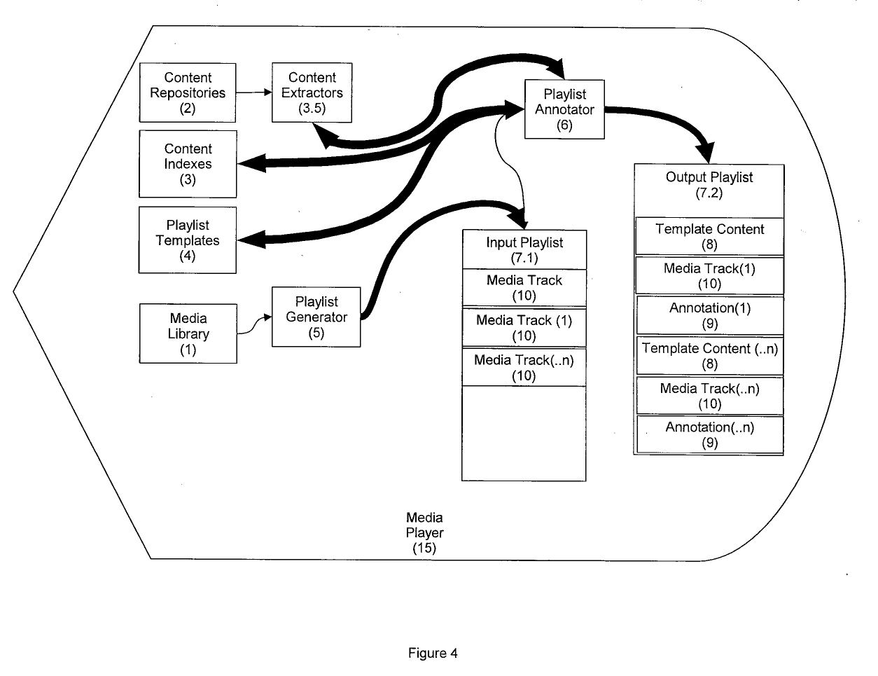

FIG. 4 illustrates another embodiment of the invention in which the invention is embodied in an all-in-one media player. In this embodiment, all the components are contained in the media player. The embodiment of FIG. 4 may be desirable for situations in which the audio annotation data comprises purely locally available information, such as the meta data contained in the media files themselves and/or personal data obtained from Personal Digital Assistant (PDA) application files such as calendar files, task files, memo files, etc.

In yet other embodiments, all of the components may be contained within a single device, except for one or more of the content repositories, which may be accessed over a communication network.

In FIGS. 2-4, it should be understood that the actual media playback device might be a separate unit from the remainder of the client-side components, such as in the case of ITunes™ (the application running on a personal computer that generates playlists) and an IPod™ (the actual media playback device which merely receives the playlist from the ITunes™ application when the IPod™ is synchronized to the ITunes™ application).

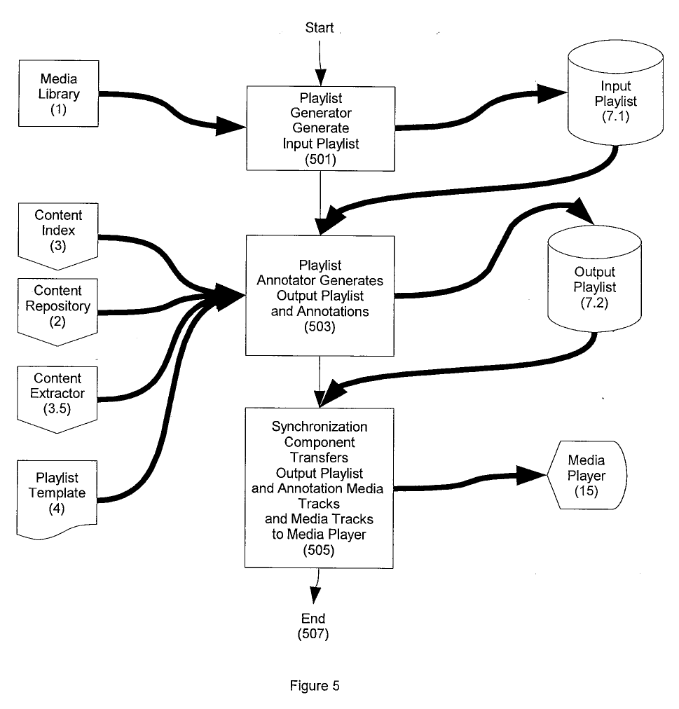

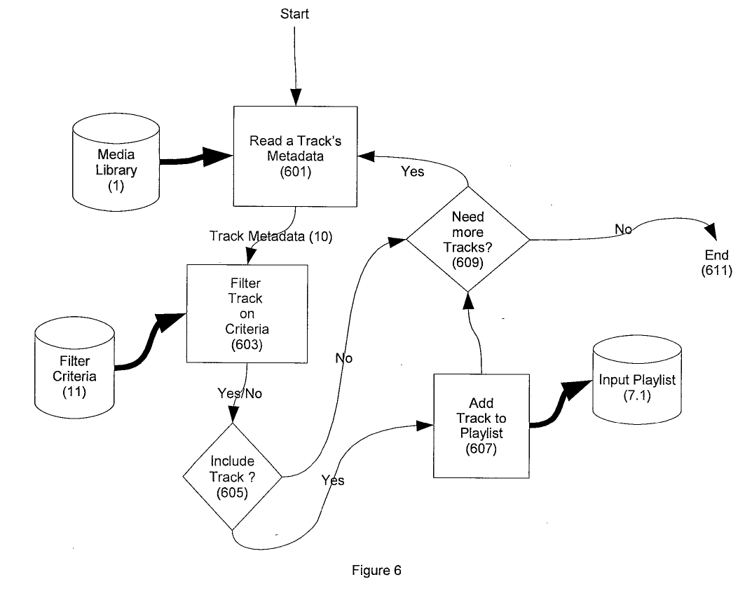

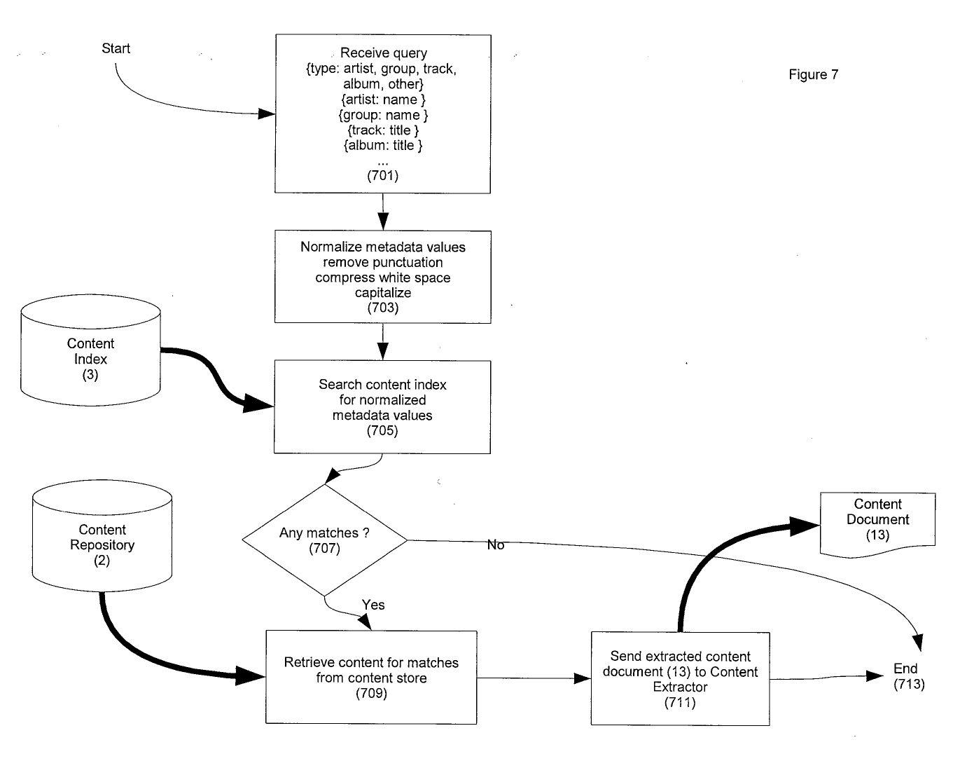

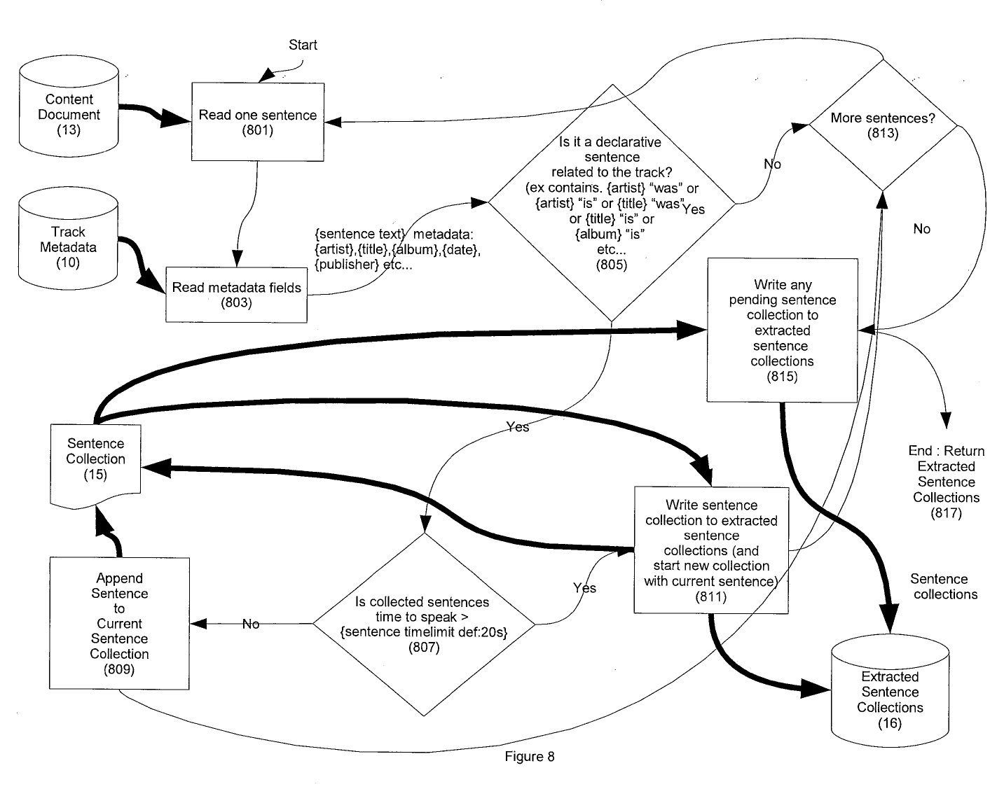

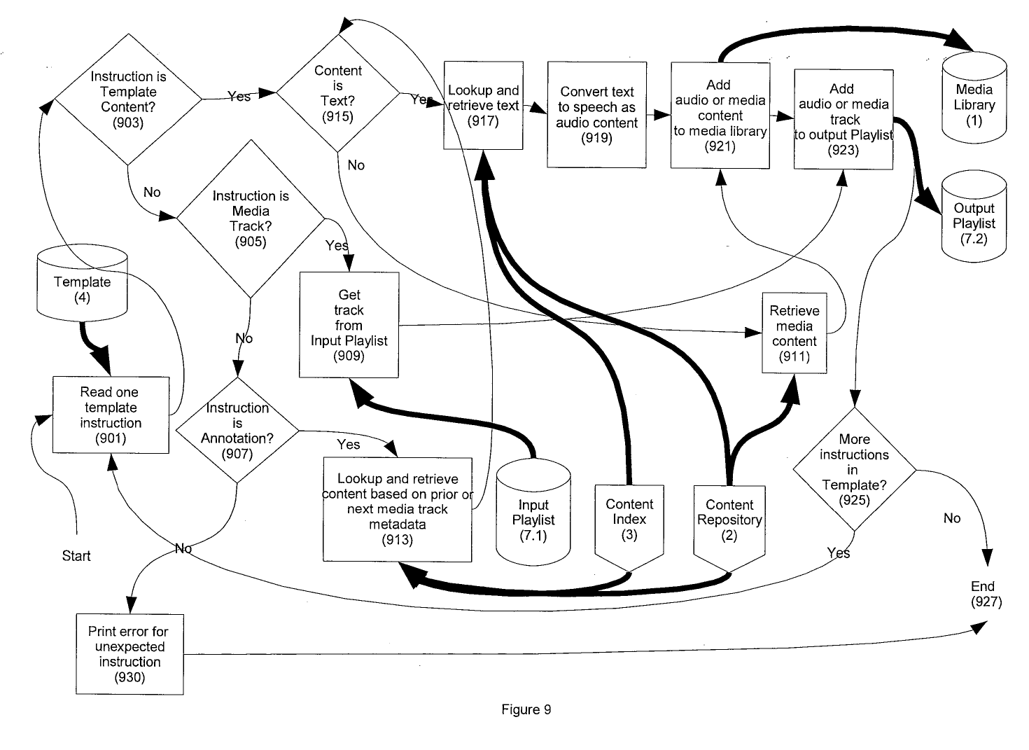

FIGS. 5-9 are flow diagrams illustrating various aspects of a particular exemplary process flow in accordance with the principles of an embodiment of the present invention. FIG. 5 illustrates general system flow. FIG. 6 illustrates process flow in connection with the playlist generator 5. FIG. 7 illustrates process flow in connection with the content index 3 and content repository 2. FIG. 8 illustrates process flow in connection with the content extractor 3.5. FIG. 9 illustrates process flow in connection with the playlist annotator 6. In FIGS. 5-9, thick lines indicate data transfer and thin lines indicate control flow. The arrows on the lines indicate the direction of data flow or control flow.

These diagrams pertain to an exemplary embodiment in which the media files are musical compositions (e.g., songs) and those media files contain meta data identifying at least the title of the song and the name of the performer. Furthermore, in this embodiment, the audio annotation will announce the title of the song and name of the performer (as derived from meta data contained in the media file itself) as well as additional information extracted from a content repository, if available. Finally, in this particular embodiment, the system automatically generates playlists based on some criteria that are either generated automatically or provided by the user.

Turning to FIG. 5, which is the general system flow diagram, in step 501, the playlist generator 5 generates an input playlist 7.1 that is to be annotated in accordance with the present invention. The details of the operation of the playlist generator are discussed in connection with FIG. 6.

In step 503, the playlist annotator 6 creates an output playlist 7.2 comprising an ordered list of the media files from the input playlist 7.1 plus annotation files containing relevant information from the content repository 2 retrieved using the content index 3 and content extractor 3.5, and organized according to a playlist template retrieved from template library 4. The processes performed using the content index 3 and content extractor 3.5 will be described below in connection with FIGS. 7, 8, and 9.

Next in step 505, the synchronization component transfers the output playlist 7.2 to the media player 15.

As previously noted, typically, a playlist 7.1 or 7.2 per se is a data file containing pointers to the actual content (i.e., the media files and the audio annotation files). Accordingly, the process of transferring the output playlist 7.2 to the media player 15 may involve transferring the playlist 7.2 per se, the newly created or retrieved audio annotation files and, possibly, the media files. In many situations, however, the media files may already reside on the media player and, therefore, may not need to be transferred.

FIG. 6 illustrates the details of step 501 of FIG. 5, namely, process flow in connection with the operation of the playlist generator 5. In step 601, the playlist generator 5 reads a media file in the media library 1 to determine the file meta data (such as performer name, song title, album, musical genre, user rating, download date, year of release, etc.). In step 602, the playlist generator 5 filters the track meta data through a criteria filter 11. The criteria either may be generated automatically or generated based on user input. For instance, the user may wish to create a playlist of songs from the 1990s, or songs within a particular genre such as alternative rock, or songs by a particular performer. Whatever the criteria, in step 605, a decision is made as to whether the track meets the criteria. If it meets the criteria, flow proceeds to step 607 where the track is added to the input playlist 7.1. If the track fails the criteria, and flow proceeds from step 605 to step 609 directly without passing through step 607. In either event, in step 609 it is determined whether there are enough tracks in the playlist. Again, the number of tracks in the playlist may be automatically set by the playlist generator 5, may be based on user input, or may be unlimited. For instance, either automatically or via user input, the list may be limited to a certain number of songs or a particular length in time. In any event, if more tracks are necessary, flow instead proceeds from step 609 back to step 601 where the next track is read and flow proceeds through steps 601 through 609 again and again until either there are no files left to check or any predefined limit has been met. When the limit has been met or there are no more files to check, flow proceeds from step 609 to step 611 where the playlist 7.1 is finalized.

FIG. 7 illustrates process flow with respect to the retrieval of content from the content repository 2 using the content index 3. These steps comprise a portion of the processes subsumed within step 503 of FIG. 5. In step 701, the content index 3 receives a query from the playlist annotator module 6. A query, for instance, comprises the song title and performer name as extracted from the meta data associated with a track in the input playlist 7.1. Of course, the meta data used for forming the query may include alternate or additional meta data as mentioned above, such as genre, album title, etc. In any event, in step 703, the module may normalize the meta data values contained in the query, such as by removing punctuation, compressing whitespaces, and capitalizing the characters. Next, in step 705, the normalized meta data values are run through the content index 3 to search for content in content repository 2 containing the terms in the normalized meta data. Let us assume for purposes of illustration that the content repository 2 in this case is the website allmusic.com, which contains detailed information about songs, performers, albums, musical genres, and all things musical.

In step 707, if a match is found, flow proceeds from step 707 to step 709. In step 709, the matching content is retrieved from the content repository 2. Next, in step 711, the retrieved content is formed into a content document 13 and sent to the content extractor. The content document 13 may be, for instance, the web page from allmusic.com for the performer identified in the song meta data. The process ends at step 713. However, on the other hand, if no match is found in step 707, flow proceeds directly to step 713 to return the results, which, in that case, would be empty.

FIG. 8 illustrates flow in connection with the content extractor module 3.5. The nature of the content extracted for insertion into an annotation file, the manner in which it is extracted, the amount that is extracted, and the manner in which it is presented are virtually limitless. FIG. 8 illustrates merely one possible process for extracting data for audio annotation.

This process starts in step 801 where the content extractor 3.5 reads the first sentence of the content document 13. For instance, this might be the first sentence of the web page content from allmusic.com pertaining to the performer in the corresponding media file. Next, in step 803, the content extractor 3.5 also reads the track meta data fields obtained from the media file. In step 805, the content extractor 3.5 runs an algorithm to determine if the sentence is a declarative sentence related to the media file (such as, for instance, by determining if the name of the performer appears within the sentence before a declarative verb, such as “was” or “is”. If so, flow proceeds to step 807 where a determination is made as to whether, if the sentence is added to the audio annotation file, the file will exceed a predetermined time limit, such as 20 seconds or a predetermined number of words, such as 150. Particularly, depending on the particular context, it may be desirable to keep audio annotation files to a relatively short duration. If the file of collected sentences does not exceed the limit, then flow proceeds to step 809 where the sentence is appended to the current sentence collection 15. Then flow proceeds to step 813. On the other hand, if the limit is exceeded, flow proceeds from step 807 to step 811. In step 811, the sentence collection is completed and written to an extracted sentence collection database 16. Furthermore, in some embodiments, the sentence that would have caused the prior collection to exceed the limit may be written to start a new sentence collection. In such embodiments, for instance, when the content of the content document 13 exceeds the time limit, it may be desirable to create multiple extracted sentence collections for the playlist annotator to choose amongst.

From either step 809 or step 811, flow proceeds to step 813 wherein the content document 13 is checked to determine whether there are more sentences in it. If so, flow proceeds back to step 801 to process the next sentence through steps 801-811.

If, however, there is no further content in the content document 13, flow instead proceeds from step 813 to step 815. In step 815, any pending sentence collection is written to the extracted sentence collection database 16. Particularly, a sentence collection would be pending when flow proceeds to step 815 via the route through steps 807, 809, and 813 because the current sentence collection has not yet been finalized since it did not reach the time, word or other limit. Also, if step 815 is reached via step 807, step 811, and the version of step 813 in which a new sentence collection is started when the content of the content document exceeds the time limit, there may be a pending sentence collection comprising only the last sentence that was used to start a new sentence collection in step 811. In any event, from step 815, flow proceeds to step 817, where the extracted sentence collection database is sent to the playlist annotator module 6.

FIG. 9 demonstrates process flow in connection with the playlist annotator 6, which takes the input playlist 7.1, a template selected from the template library 4, and the extracted sentence collections and builds the audio annotation files and interleaves them with the media files of the input playlist 7.1 to generate the output playlist 7.2. In step 901, the playlist annotator 6 selects a template from the template library 4, which template will dictate the format for the audio annotation file. As previously noted, there may be only a single template. However, in more robust embodiments, there may be different templates for different types of media files or different purposes. The particular template may be chosen by user input or automatically selected as a function of meta data found in the files of the playlist that is being annotated. In any event, in step 901, a first instruction in the template is read. In step 903, it is determined whether the instruction is a template content instruction. By template content instruction, it is meant that the instruction creates part of the boilerplate content of the template, for instance, an instruction to insert the words “That was” (which will then be followed by an audio annotation file providing the song title). Another example would be instructions concerning how to interleave an annotation file within an input playlist.

If it is not template content, flow proceeds to step 905, where it is determined if the instruction asks for a media file from the input playlist 7.1. For instance, the templates will, in the present example, indicate that the output playlist is to comprise all of the media tracks contained in the input playlist 7.1 interleaved with an audio annotation track corresponding to each media file positioned immediately after the media file to which it corresponds. If the instruction does not ask for a media track, then flow proceeds from step 905 to step 907.

In step 907, it is determined whether the instruction is an annotation instruction. An annotation instruction refers to an instruction involved in the creation of an audio annotation. Such content may include, for instance, meta data derived from the corresponding media file, such as the song title and performer name and/or data obtained from the content repository 2, such as a biography of the performer. If the instruction is not any of an annotation instruction, template content, or media content, then the instruction is invalid and flow proceeds to 930 where an error message is printed and then flow exits at 927.

In any event, returning to step 903, if the instruction is a template content instruction, then flow proceeds to step 915, where it is determined whether the content is text. If text, flow proceeds to step 917, wherein the text is retrieved. Next, in step 919, the text is run through a text-to-speech converter to transform it into an audio annotation file.

Next, in step 921, the audio annotation file is added to the media library 1. In step 923, the audio annotation file is added to the playlist in the proper position. In step 925, the audio annotator 6 checks if there are further instructions in the template. If so, flow proceeds back to step 901. If not, flow proceeds to step 927 where the output playlist is finalized.

If the template instruction is not text, then it is assumed that it is media content and flow instead proceeds from step 903 to step 911 in which the corresponding media content is retrieved. Particularly, as previously noted, not all template content or annotation content necessarily comprises text that must be converted to audio. It may already be stored as audio (or other media). For instance, template content such as “That was” may be originally stored as audio data, rather than text that must be converted to audio. Furthermore, some of the template content or even annotation content might comprise non-speech audio (or other media) content, such as background music. In any event, flow proceeds from step 911 to step 921 where, as previously described, the content is added to the media library 1. Flow then proceeds to step 923, where the audio annotation file is added to the output playlist 7.2 and flow again proceeds to step 925 to determine if there are more instructions in the template.

Turning to instructions that request media files, flow would proceed from step 905 to step 909. In step 909, the requested media file is retrieved from the input playlist (or, more likely, a pointer to the location of the media file on the media player 15 is created). Flow then proceeds to step 923 where that media track (or the pointer to it) is added to the output playlist 7.2. Flow then proceeds to step 925 where it is determined if there are more instructions in the template. If so, flow proceeds back to step 901. If not, the output playlist is finalized in step 927.

Finally, if the instruction is determined in step 907 to be an annotation instruction, flow proceeds from step 907 to step 913. In step 913, the playlist annotator retrieves the annotation content and flow proceeds to step 915. As previously described, step 915 determines whether the content is text. If the audio annotation content retrieved in step 913 is determined to be text, flow proceeds through steps 917, 919, 921, and 923 as previously described. If it is media, then flow proceeds through steps 911, 921, and 923 also as previously described. Briefly, if text, in step 917 the text is retrieved, in step 919 it is converted to speech. If not text, then in step 911 the media file is retrieved instead. In either event, in step 921 an audio annotation file is created and placed in the media library 4, and in step 923, that audio file is inserted in the proper position within the output playlist.

Flow then proceeds again to step 925 and the process flows back to step 901 to continue processing instructions until there are no more instructions in the template, at which point the flow will proceed from step 925 to step 927 where the output playlist is finalized.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method of annotating a playlist of media files comprising the steps of:
receiving an input playlist comprising a plurality of media files;
generating supplemental media content about content within at least one of the media files;
inserting the supplemental content into the input playlist to create an output playlist comprising the media files of the input playlist and the supplemental media content.

2. The method of claim 1 wherein the generating step comprises:
extracting meta data from within the at least one media file; and
converting the extracted meta data into media data.

3. The method of claim 2 wherein the step of converting comprises converting text to speech.

4. The method of claim 1 wherein the step of generating comprises:
querying a content repository for information relevant to the at least one media file;
finding information in the content repository responsive to the query; and
converting the information into media data.

5. The method of claim 4 further comprising the step of:
extracting meta data from the at least one media file; and
formulating the query as a function of the extracted meta data.

6. The method of claim 1 wherein the input playlist comprises an ordered list of the media file and wherein the step of inserting comprises positioning the supplemental content in the list immediately adjacent the at least one media file to which it corresponds.

7. The method of claim 1 further comprising the steps of:
retrieving a playlist template from a playlist template library; and
using the retrieved playlist template to build the output playlist.

8. The method of claim 1 wherein the supplemental media content is stored in a media form and the step of generating the supplemental media content comprises retrieving the stored supplemental content.

9. The method of claim 1 wherein the step of generating the supplemental media content comprises converting content stored in text form from text form to a media form.

10. The method of claim 1 wherein the supplemental media content is in the same form of media as the media file to which it corresponds.

11. The method of claim 1 further comprises the step of automatically generating the input playlist.

12. The method of claim 4 wherein the step of generating the supplemental content comprises:
generating a content document containing content found in the content repository responsive to the query; and
processing the data in the content document to extract a subset of data as the supplemental content.

13. The method of claim 12 wherein the step of generating the supplemental content further comprises:
converting the subset of data from a non-media form into a media file.

14. The method of claim 4 wherein the method is implemented in a network and the content repository is located at a first node on the network separate from a second node on the network at which the output playlist is generated.

15. The method of claim 14 wherein the content repository is located at a separate network node than a node at which the query is generated and the information is converted.

16. A computer program product stored on a computer readable medium for creating an annotated playlist comprising:
receiving an input playlist comprising a plurality of media files;
computer executable instruction for extracting meta data from the media files in the playlist;
computer executable instruction for querying a content repository for information pertaining to the extracted meta data from the media files;
computer executable instruction for receiving information from the content repository responsive to the query;
computer executable instruction for converting the information received from the content repository into supplemental media files of a same type of media as the media files in the input playlist; and
computer executable instruction for interleaving the supplemental media files with the media files of the input playlist to generate an output playlist.

17. The method of claim 16 wherein the computer executable instruction for converting comprise computer executable instruction for converting text to speech.

18. A computer program product stored on a computer readable medium for creating an annotated playlist comprising:
receiving an input playlist comprising a plurality of media files;
computer executable instruction for extracting meta data from the media files in the playlist;
computer executable instruction for converting the meta data into supplemental media files of a same type of media as the media files; and
computer executable instruction for interleaving the information received from the content repository with the media files in the input playlist to generate an output playlist.

19. The method of claim 18 wherein the computer executable instruction for converting comprises computer executable instruction for converting text to speech.

20. A method for annotating a playlist of media files comprising:
obtaining digital information stored in a non-media format;
converting the digital information into a first media file; and
inserting the first media file into a playlist comprised of at least one second media file.

21. The method of claim 20 wherein the first media file and the second media file are of the same file type.

22. The method of claim 20 wherein at least one second media file comprises a plurality of audio files and the digital information comprises personal data.

23. The method of claim 20 wherein the obtaining digital information comprises obtaining digital information from a personal digital assistant application software module.
